(19) United States
(12) Patent Application Publication
(10) Pub. No.: US 2023/0268812 A1
(43) Pub. Date: Aug. 24, 2023

(54) METHOD FOR CORRECTING A PORTION OF A MATERIAL LAYER, MATERIAL LAYER, AND DYNAMOELECTRIC MACHINE

(71) Applicant: Siemens Aktiengesellschaft, München (DE)

(72) Inventors: Carsten Schuh, Baldham (DE); Thomas Soller, Deggendorf (DE); Rolf Vollmer, Gersfeld (DE)

(73) Assignee: Siemens Aktiengesellschaft, München (DE)

(21) Appl. No.: 18/012,138

(22) PCT Filed: Apr. 12, 2021
(86) PCT No.: PCT/EP2021/059373

§ 371 Date: Dec. 21, 2022

(30) Foreign Application Priority Data
Jun. 22, 2020 (EP) 20181397.9

(51) Int. Cl. H02K 15/00; H02K 15/02; H02K 15/12

(52) U.S. Cl. CPC H02K 15/0006; H02K 15/02; H02K 15/12; H02K 2213/03

(57) ABSTRACT

In a method for correcting a portion, in particular a tooth, of a material layer of a dynamoelectric machine, with the material layer including a soft-magnetic material and having a layer thickness between 0.5 and 500 μm, an actual geometry of the portion of the material layer is ascertained and compared to a target geometry. A deviation of the actual geometry from the target geometry is determined. Before the deviation is corrected by partially plastically deforming the material layer using a light source, the material layer is partially heated by a further light source.

The invention relates to a method for correcting a material layer.

A method for producing a material layer having a layer thickness between 0.5 and 500 μm is described in patent specification EP 3 595 148 A1, having the following steps: applying a suspension, having at least one binder and solid particles, through a template onto a base to obtain a green body, expelling the binder from the green body, in particular by means of debinding, creating a permanent cohesion of the solid particles by heating and/or by means of compaction, in particular by means of sintering.

Material layers produced in this way usually have higher geometric tolerances than conventional plates or magnetic plates, in particular those produced by means of stamping. In particular a location tolerance of the teeth or individual teeth results in problems. Upon a concatenation of material layers, in particular stacking, to form a material layer microstructure, a deviation of actual positions and/or actual geometries of the teeth from target positions and/or target geometries has the result, among other things, that the teeth of the individual material layers are not located congruently one over another and therefore a clear width of a groove channel located between the teeth decreases in the material layer microstructure and therefore less current-conducting material, in particular copper coils, can be introduced.

The invention is based on the object of improving a material layer microstructure for a stator of a dynamoelectric machine.

The object is achieved by claim 1, i.e., a method for correcting a portion, in particular a tooth, of a material layer, wherein the material layer has a layer thickness d between 0.5 and 500 μm, in particular between 10 and 100 μm, wherein the material layer comprises a soft-magnetic material, having the following steps:
ascertaining an actual geometry, preferably by means of an optical unit,
comparing the ascertained actual geometry to a target geometry,
determining a deviation of the actual geometry from the target geometry,
partially plastically deforming the material layer by means of a light source to correct the deviation.

The plastic deformation is carried out, for example, by pressure or force action, for example by means of a press.

An embodiment is preferred, according to which the partial plastic deformation is a partial thermal plastic deformation.

The plastic deformation is thus advantageously accompanied by heating.

Thermal plastic deformation means: Plastic deformation promoted or induced by heat action.

“Induced” includes, for example, a plastic deformation which arises due to a mechanical tension occurring upon cooling of a molten area.

“Promoted” describes cases, for example, in which a solidity is reduced by heat action—so that a lesser force is required for deformation—without the material having to be melted.

The material layer is not brought to a melting temperature in this case, but rather a temperature is below the melting point of the material layer.

An embodiment is preferred, according to which the plastic deformation is a partial melting.

The object is thus particularly preferably achieved by claim 3, i.e., a method for correcting a portion, in particular a tooth, of a material layer, wherein the material layer has a layer thickness between 0.5 and 500 μm, in particular between 10 and 100 μm, wherein the material layer comprises a soft-magnetic material, having the following steps:
ascertaining an actual geometry, preferably by means of an optical unit,
comparing the ascertained actual geometry to a target geometry,
determining a deviation of the actual geometry from the target geometry,
partially melting the material layer by means of a light source to correct the deviation.

The optical unit can be an optical measuring unit. The optical unit is preferably a scanner. However, the optical unit can also be embodied as a camera. Other embodiments of the optical unit are also conceivable.

The material layer advantageously possesses the previous functions of a conventional plate in a conventional laminated core and assumes the tasks of a plate.

An outline of the material layer advantageously essentially corresponds to the outline of a plate.

The material layer is advantageously thinner than a conventional plate.

The material layer microstructure advantageously possesses the previous functions of a laminated core and assumes the tasks of a laminated core.

The material layers are arranged one on top of another to provide the material layer microstructure. The material layers are preferably arranged in the direction of an axis of rotation, in other words: along an axis of rotation, of the material layer microstructure. In one advantageous embodiment, the light source is a laser.

The correction is preferably carried out in this case by means of laser beam forming. This offers the advantage that selective correction is possible.

Preferably, a warpage, which occurs upon the plastic deformation, preferably thermal plastic deformation, in particular melting, of material and subsequent re-solidification, is utilized to achieve a geometry change. A tooth base is advantageously partially deformed, in particular melted, in such a way that the warpage occurring upon re-solidification is such that a tooth head, preferably in compliance with a maximum tolerance of less than 5 μm, in particular less than 2 μm, adapts to the target geometry.

In one advantageous embodiment of the invention, the material layer is plastically deformed, preferably thermally plastically deformed, in particular melted, at a tooth base (in other words: in the region of the tooth base). This is used in particular for rotating the tooth head.

The tooth base is an area at which the tooth merges into the yoke. Material can also be plastically deformed, preferably thermally plastically deformed, in particular melted, at the tooth neck (in other words: tooth flank), thus between tooth base and tooth head.

Other areas of the material layer can also be deformed or melted to change a geometry and/or position.

In a further advantageous embodiment, the light source is an LED.

An electron beam can also be used as a light source. Other light sources are also conceivable which enable melting or a plastic deformation.

A maser can also be used as the light source. It is also conceivable to use other sources which emit electromagnetic waves. Bundled electromagnetic waves can also be used.

In a further advantageous embodiment, the material layer is partially heated by a further light source before the plastic deformation, in particular the partial melting. This preheating is advantageously carried out using a laser and/or an LED. Other light sources are also conceivable.

It is also conceivable that an ambient temperature between 200° C. and 600° C., preferably between 300° C. and 500° C., is provided and the material layer is heated in this way (for example in a furnace).

The further light source is preferably a preheating light source, the above-explained light source is preferably a melting light source.

It is also possible that only one combined light source assumes the function of the preheating light source and the function of the melting light source.

In one advantageous embodiment, the light source has a beam intensity between 80 kW/cm² and 120 kW/cm², in particular between 90 kW/cm² and 110 kW/cm².

The mentioned values are advantageously oriented to a material of the material layer, in particular a thermal conductivity of the material.

The light source advantageously has a focus size between 0.005 mm and 10 mm, preferably between 50 μm and 150 μm.

The focus size corresponds in this case to a diameter of the light source at the moment of incidence on the material layer. The focus size is advantageously smaller than the layer thickness of the material layer.

The light source advantageously has an exposure time between 0.1 ms and 100 ms.

The light source preferably pulses during the exposure time, i.e., during the exposure time, the light source emits at least two light pulses. A light pulse has, for example, a pulse duration between 1 fs and 100 ps.

These properties result in optimum warpage of the material.

In one advantageous embodiment, the further light source has a beam intensity between 1 kW/cm² and 10 kW/cm² auf.

The further light source advantageously has a focus size between 1 mm and 5 cm, preferably between 1 cm and 5 cm.

The further light source advantageously has an exposure time between 1 ms and 100 ms.

The further light source preferably does not pulse. Preheating and deformation or melting are preferably synchronous, i.e., the exposure time of the further light source (preheating light source) and the exposure time of the light source (deforming light source or melting light source) are at least essentially equal in length.

The mentioned properties of the further light source during preheating offer the advantage that a penetration depth of a melt pool induced by the deforming light source or melting light source is increased.

At higher temperatures, an absorption of the radiation of the deforming light source or melting light source by the material moreover improves, a required beam intensity and exposure time can thus be reduced.

The object stated above is furthermore achieved by claim 15, i.e., a material layer corrected according to such a method, wherein the material layer has a layer thickness between 0.5 and 500 μm, in particular between 10 and 100 μm.

The corrected material layer preferably comprises an insulation material on at least one layer side. The method for correction is advantageously carried out before an application of insulation material. However, it is also possible to carry out the method for correction after the application of insulation material.

The soft-magnetic material is, for example, iron, nickel, cobalt, and/or the alloys thereof. However, other magnetically conductive, in particular ferromagnetic materials are also conceivable.

The insulation material is preferably enamel, in particular baked enamel. The insulation material, in particular the baked enamel, and the material layer are preferably connected by material bonding.

In an alternative embodiment, the insulation material is ceramic. Other insulation materials are also possible.

The object stated above is also achieved by claim 16, i.e., a material layer microstructure for a dynamoelectric machine, wherein the material layer microstructure has a plurality of material layers arranged one on top of another.

In addition, the object is achieved by claim 17, i.e., a dynamoelectric machine, having such a material layer microstructure.

The invention is suitable both for dynamoelectric rotational machines and for linear machines, in particular linear motors.

The invention offers the advantage that a dimensional accuracy is significantly increased by a single-tooth-specific reduction of the location tolerances. This in turn offers the advantage that building up material layer microstructures can be simplified and even automated.

A further advantage is that material layers, which were produced in particular according to a method described in patent specification EP 3 595 148 A1, can be assembled by the invention to form material layer microstructures which only have minor tolerances, by which a lower torque ripple can be achieved in dynamoelectric machines. Moreover, such material layer microstructures enable a high performance of the dynamoelectric machine. Moreover, such machines are quiet and low-vibration.

The invention moreover offers the advantage that the correction by means of a light source is usable independently of design and universally. The described method is additionally cost-effective and fast and moreover also applicable for large series.

Assembling the material layer microstructure and the dynamoelectric machine is significantly facilitated by the invention.

The invention is particularly well suitable for machines, in particular motors, which require a high performance at low weight, in particular in aircraft, helicopters, and Formula E racecars. The invention is also suitable for applications in which machines are moved on traverses and are therefore to be particularly light. These include, among other things, exoskeletons, robots, and suspended axles in general.

The invention is suitable for all types of machines which have material layers. These include in particular asynchronous machines, synchronous machines, and reluctance machines.

The invention is described and explained in more detail hereinafter on the basis of the exemplary embodiments shown in the figures. In the figures:

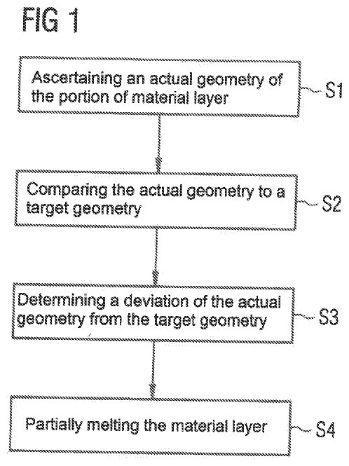

FIG. 1 shows a possible sequence of the method according to the invention,

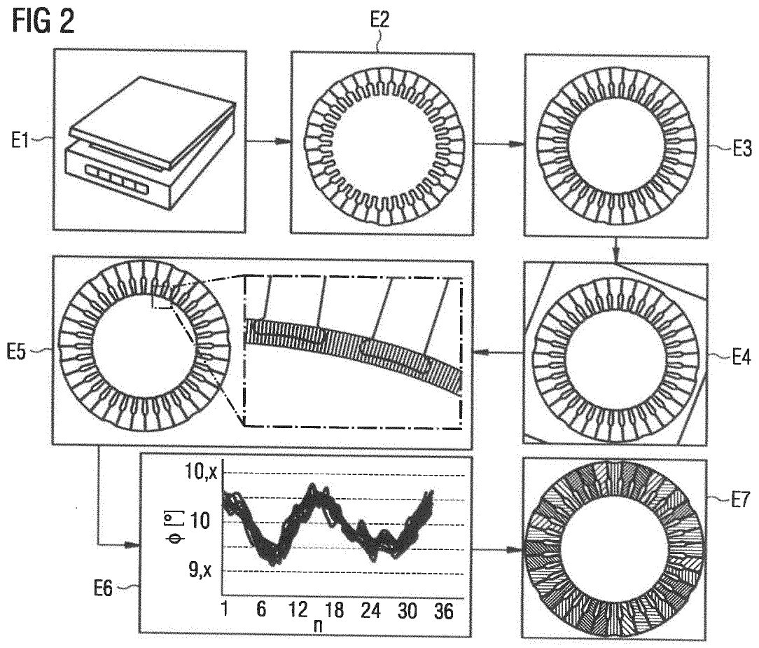

FIG. 2 shows a possible method for ascertaining an actual geometry of a portion,

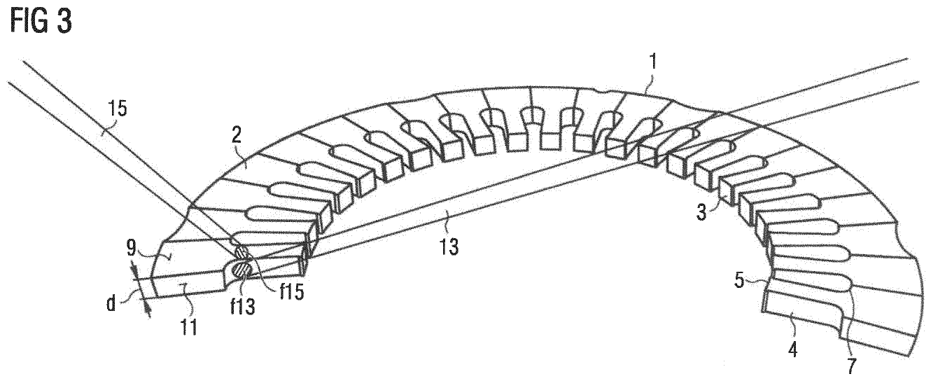

FIG. 3 shows partial melting,

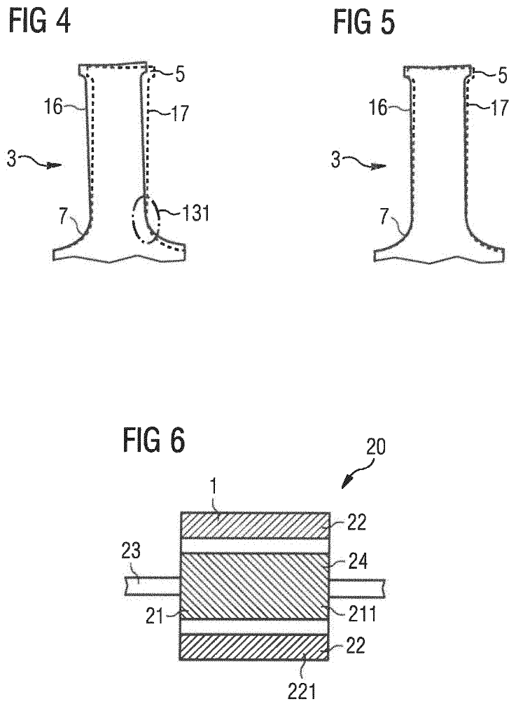

FIG. 4 shows a tooth before a correction,

FIG. 5 shows the tooth after a correction, and

FIG. 6 shows a dynamoelectric rotational machine.

FIG. 1 shows a possible sequence of the method according to the invention for correcting a portion of a material layer 1.

The method according to the invention is explained on the basis of the example “melting”. However, the method can be carried out similarly by means of “plastic deformation”, in particular “thermal plastic deformation”.

The portion is preferably a tooth of a material layer.

In a method step S1, an actual geometry of the portion is ascertained by means of an optical unit. The ascertainment of the actual geometry is described in more detail in FIG. 2.

In a method step S2, the ascertained actual geometry is compared to a target geometry.

In a method step S3, a deviation of the actual geometry from the target geometry is determined.

In a method step S4, the material layer is partially melted by means of a light source. The light source is preferably embodied in this case as a laser, however, it is also possible that the partial melting is carried out by means of an LED.

The partial melting is described in more detail in FIG. 3. FIG. 2 shows a possible method for ascertaining the actual geometry of the portion.

The ascertainment of the actual geometry is carried out by means of an optical unit. For example, a flatbed scanner or a line scanner or also a camera can be used. Other scanners or devices which enable a representation by means of an imaging method are also suitable.

A scanner offers the advantage that the component to be measured can be depicted particularly well at a high resolution on a large area. For example, details in the range between 10⁻² and 10⁻³ mm can be recorded and reproduced on an area between 10⁴ and 10 mm².

In a method step E1, a material layer is measured using the optical unit, in particular using a scanner.

In a method step E2, a raw file of the material layer is generated. This is advantageously a raw image of the material layer in front of a preferably monochromatic and/or matte background.

In a method step E3, the raw file is cropped and binarized, in particular in a color-based manner. The file is advantageously converted into a black-and-white image.

The resulting image can then optionally be aligned on the basis of a marking mark in method step E4.

In a method step E5, by ascertaining the black/white transitions, the actual geometry of at least one tooth, preferably each tooth, is determined.

In a method step E6, a deviation with respect to a target geometry is quantified and in method step E7, it is visualized. Misalignments which are smaller than 5 μm can be recognized in this method.

FIG. 3 shows the partial melting.

The example “melting” in this Figure is selected for better comprehension. It is possible to carry out the method similarly by means of thermal plastic deformation.

The Figure shows a detail of a material layer 1, which is suitable for a stator 22 of a dynamoelectric machine 20.

The material layer 1 has a layer thickness d between 0.5 and 500 μm, in particular between 10 and 100 μm. The material layer 1 comprises a soft-magnetic material. The material layer 1 can comprise an insulation material 2 on at least one layer side.

The Figure shows a plurality of teeth 3. Each tooth 3 has a tooth head 5, a tooth neck 4, and a tooth base 7. The Figure furthermore shows an end face 9 and a lateral surface 11. Moreover, a straightening laser beam 13 and a preheating laser beam 15 are shown in the Figure.

The straightening laser beam 13 in the Figure is the above-explained light source or melting light source. Another type of light source can also be used, for example, an LED.

The preheating laser beam 15 in the Figure is the above-explained further light source or preheating light source. Another type of light source can also be used, for example, an LED.

Partial misalignments, in particular of the teeth, are selectively corrected by means of the straightening laser beam 13. In this case, a warpage occurring upon melting by means of the straightening laser beam 13 and subsequent re-solidification of the material is utilized to achieve a shape change.

In order, for example, to rotate a tooth 3 in the material layer plane and correctly align it, a straightening laser beam 13 having a focus size f13 having preferably low beam intensity (advantageously up to about 100 kW pro cm²) is focused in the area of the tooth base 7 on the lateral surface 11 and the material is melted once or multiple times in spots or in a planar manner. A small warpage in the area of the tooth base is sufficient here to effectuate a sufficiently large rotation of the tooth head 5.

The strength of the rotation can be controlled in this case via various dimensions, for example, via the laser intensity, focus size, and/or exposure time, The focus size corresponds in this case to a diameter of the respective light source at the moment of incidence on the material layer. The focus size is advantageously less than the layer thickness of the material layer.

The area of the tooth base 7 can optionally be preheated via the preheating laser beam 15 having a focus size f15. The preheating laser beam 15 is preferably aimed at the end face 9, as shown in the Figure. An even higher penetration depth of the melt pool is thus achieved.

Targeted straightening of the material layer is possible by way of the straightening laser beam 13 and the optional preheating laser beam 15. Misalignments of, for example, 100 μm can be corrected to less than 20 μm.

The statements on FIG. 3 also apply to other light sources, for example LEDs.

FIG. 4 shows the tooth 3 before the correction. FIG. 5 shows the tooth 3 after the correction.

The two Figures show the tooth 3 having the tooth head 5 and the tooth base 7.

Furthermore, the two Figures show an actual geometry 16 and a target geometry 17.

Moreover, an exposure zone of the straightening laser 131 is shown in FIG. 4. A dear deviation of the actual geometry 16 from the target geometry 17 is shown in FIG. 4, before the straightening laser beam 13 acts.

FIG. 5 clearly shows that the actual geometry 16 of the corrected tooth 3 only still has a very minor deviation, which is sometimes to be neglected, with respect to the target geometry 17. The before and after comparison from FIGS. 4 and 5 shows how the action of the laser on the tooth base 7 enables a rotation of the tooth head 5.

FIG. 6 shows a dynamoelectric rotational machine 20 having a rotor 21, a stator 22, and a shaft 23.

The stator 22 preferably has a plurality of material layers 1. These are arranged as a stator material layer microstructure 221.

The rotor 21 has a plurality of material layers 24. These are arranged as a rotor material layer microstructure 211.

The material layers 24 can experience a similar correction using the described method. For example, the invention can be used for a correction of material layers of grooved rotors or also for the shape change of pockets for internal permanent magnets. Moreover, a roundness of reluctance rotors can be improved to achieve a uniform air gap.

1.-17. (canceled)

18. A method for correcting a portion, in particular a tooth, of a material layer of a dynamoelectric machine, with the material layer comprising a soft-magnetic material and having a layer thickness between 0.5 and 500 μm, said method comprising:
ascertaining an actual geometry of the portion of the material layer;
comparing the actual geometry to a target geometry;
determining a deviation of the actual geometry from the target geometry; and
before subjecting the material layer to a partial plastic deformation by a light source to correct the deviation, partially heating the material layer by a further light source.

19. The method of claim 18, wherein the material layer has a layer thickness between 10 and 100 μm.

20. The method of claim 18, wherein the actual geometry of the portion is ascertained by an optical unit.

21. The method of claim 18, wherein the material layer is partially heated to cause a partial melting.

22. The method of claim 18, wherein the partial plastic deformation is a partial thermal plastic deformation.

23. The method of claim 18, wherein the plastic deformation is a partial melting.

24. The method of claim 18, wherein the light source is a laser.

25. The method of claim 18, wherein the light source is an LED,

26. The method of claim 18, further comprising plastically deforming, in particular melting, the material layer at a tooth base of a tooth.

27. The method of claim 18, wherein the light source has a beam intensity of between 80 kW/cm² and 120 kW/cm², in particular between 90 kW/cm² and 110 kW/cm².

28. The method of claim 18, wherein the further light source has a beam intensity between 1 kW/cm² and 10 kW/cm².

29. The method of claim 26, wherein the tooth base is partially deformed, in particular melted, in such a way that a warpage occurring upon re-solidification is such that a tooth head of the tooth adapts to the target geometry.

30. The method of claim 18, wherein the light source has a focus size between 0.005 mm and 10 mm, preferably between 50 μm and 150 μm.

31. The method of claim 18, wherein the further light source has a focus size between 1 mm and 5 cm, preferably between 1 cm and 5 cm.

32. The method of claim 18, wherein the light source has an exposure time between 0.1 ms and 100 ms.

33. The method of claim 18, wherein the further light source has an exposure time between 1 ms and 100 ms.

34. A material layer for a dynamoelectric machine, said material layer being corrected by a method as set forth in claim 18, said material layer having a layer thickness between 0.5 and 500 μm, in particular between 10 and 100 μm, and comprising a soft-magnetic material.

35. A material layer microstructure for a dynamoelectric machine, said material layer microstructure including a plurality of material layers arranged one on top of another, each said material layer being corrected by a method as set forth in claim 18, said material layer having a layer thickness between 0.5 and 500 μm, in particular between 10 and 100 μm, and comprising a soft-magnetic material.

36. A dynamoelectric machine, comprising a material layer microstructure as set forth in claim 35.
